(19) United States
(12) Patent Application Publication
(10) Pub. No.: US 2005/0147227 A1
(43) Pub. Date: Jul. 7, 2005

(54) Method and system for alerting call participant of a change in a call hold status

(75) Inventors: Srinivas Chervirala, Santa Clara, CA (US); Satya Mallya, San Jose, CA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, S.A., Paris (FR)

(21) Appl. No.: 10/748,150

(22) Filed: Dec. 31, 2003

(51) Int. Cl. H04M 3/42

(52) U.S. Cl. 379/215.01; 379/207.04

(57) ABSTRACT

A method and system for controlling a connection between a calling party and a called party. When a call is placed on hold, detection services are utilized to determine when the call changes from being “on hold” to being active. The call control system can then contact the caller to inform the caller of the change in the status of the call. Such contacts can be either in-band or out-of-band. If the caller is unable to respond to the change in call status, the called party can leave a message for the caller.

### BACKGROUND OF THE INVENTION

1. Field of the Invention

The present invention is directed to a method and system of alerting a call participant that a change has occurred in the status of a call that was previously on hold, and, in one embodiment, to a method and system of alerting a user that has taken or placed a second call while on hold on a first call that the first call has now come off of hold.

2. Discussion of the Background

Telephonic customer support is becoming an increasingly popular means of providing services to remote customers. To receive such services, customers often call a toll-free number (e.g., an 800 or 877 number in the United States) which is actually routed to a call center with a number of operators. During busy times, the number of inbound calls may often exceed the number of available customer service agents, thereby preventing all the customers from immediately being connected with a customer service agent.

When the number of inbound calls exceeds the number of available customer service agents, call centers can respond in a number of ways: (1) generate a busy signal which the customer may find abnormal; (2) connect the call to a phone service that generates or plays a pre-recorded message indicating that all agents are busy and that the customer should call back later whereupon the call is automatically terminated; or (3) connect the call to a phone service that generates or plays a pre-recorded message indicating that all agents are busy and that the customer should remain on hold such that the customer's call will be answered in the order in which it was received. Sometimes such a pre-recorded message is supplemented with information on the expected wait time until an agent will become available.

However, once on hold many customers become frustrated by a feeling of being shackled to the phone without a good indication of when they will actually be helped. This situation is made worse when the caller receives another call via a call-waiting service. When another call is present, the caller has the dilemma of deciding whether to answer the call and risk that the customer service agent will come on while the caller is on the second call. As many customers may have experienced, it is frustrating to switch back to the first call (previously on hold) after having answered the second, call waiting call, only to find that the first call terminated when a customer service agent did not find anyone on the line when the agent answered the call originally on hold. At that point, the caller has lost his “investment” or “place in line” on the first call and has to get back in line by recalling the customer service center. Often callers simply give up and do not actually call back; however, this may adversely affect how a customer perceives the product or service associated with the call.

### SUMMARY OF THE INVENTION

It is an object of the present invention to provide an indication to the caller that is on hold that the person, agent or service that the caller was on hold with is now available to speak with the caller.

In one embodiment of the present invention, the caller will receive an audible or visual notification that a previously held call has become active such that the caller should switch back to the original call in a timely fashion.

### BRIEF DESCRIPTION OF THE DRAWINGS

These and other advantages of the invention will become more apparent and more readily appreciated from the following detailed description of the exemplary embodiments of the invention taken in conjunction with the accompanying drawings, where:

FIG. 1 is a block diagram of a system for providing notifications to a caller that a previously held voice line has become active;

FIG. 2 is a block diagram of an embodiment of the voice detection and response module 105 of FIG. 1; and

FIG. 3 is a flowchart of a possible series of events that enables a call participant to be notified that a previously held voice line has become active.

### DETAILED DESCRIPTION OF THE PREFERRED EMBODIMENTS

To better place the utility of the present invention in context, one can consider two examples.

Scenario #1

‘Scott’ is business traveler, who, in the midst of his hectic schedule wants to confirm his flight ticket to Florida with his preferred airline. ‘Scott’ has a multi-line communications terminal, which could be a fixed-line IP phone; circuit switched networked phone, mobile phone, or any other communication device. Scott utilizes his multi-line communications terminal to call his preferred airline, but due to high call volume, he is kept on hold. The approximate waiting time for someone to answer his call is about 10 minutes.

At the same time, Scott also wants to speak with his colleague, ‘Sean,’ to discuss the last minute changes in his proposed presentation to executive board. As Scott has very little time to complete both of these tasks, he cannot afford to simply disconnect his call to his preferred airline and speak with Sean, as he may run in to the risk of not getting confirmation from airlines in time. At the same time, the discussion with Sean is equally important.

In the above situation, Scott has three options: one is waiting until his call is answered by the airline and calling Sean afterwards, which will be difficult because he has very little time left. The second option is to disconnect his call with airline, complete his discussion with Sean, and then call the airline back. In this second approach, however, Scott runs the risk of losing his position in the queue. Thus, when Scott calls back, he runs the risk that his waiting time will be longer (potentially much longer). A third option is to place a second call to Sean while on hold with the first call and hope that he gets back to the first call before agent on the first call hangs up on Scott.

The proposed service/solution addresses the problem for a subscriber of this service, as a change in the online status of the call to the customer service agent in the third option can be signaled as soon as the agent says ‘Hello’ or the pre-recorded music ends. This allows the ability to use a second phone line in the terminal, thereby allowing Scott to call Sean and discuss his presentation without the fear of losing the airline call. The notification can be by any one or a combination of a distinctive beep, instant messaging, a display or through voice prompt insertion.

Scenario #2

In the second scenario, ‘Peter’ has a call-waiting feature in his communications terminal, which could be a fixed-line IP phone; circuit switched networked phone, mobile phone, or any other communication device. Further, Peter calls Johnson, and Johnson answers. While that conversation is taking place, Peter receives notification through his call-waiting feature that someone else (Joe) is calling him. (Notification in PSTN is in short beeps or through voice prompt insertion, on PBX solutions a flashing second line indication, etc).

As Peter urgently needs to talk with Joe, he indicates to Johnson that he is going to be back after a short conversation with Joe. Peter then switches to the other line and has a conversation with Joe. Unfortunately, Peter soon becomes immersed in his conversation with Joe, and forgets about Johnson waiting on the other line. Since it's taking a lot of time, Johnson wants to inform Peter that he'll call back Peter later or might want to get his immediate attention or be able to whisper to Peter a short message while Peter continues his dialog with Joe. However, using known services, Johnson can't communicate such information with Peter.

In both such scenarios, an existing communications system controlling the interaction between the communicating parties is enhanced to include the ability to further communicate between the parties after a call is established but while not actually engaged in an active conversation with the other side. In one embodiment of the present invention, a call control system 100 includes at least one switch (e.g., 4ESS/5ESS switch 125 and GSM MSC 135) that initially establishes a connection between a caller 200 and a called party 210 (for example a call center providing customer support) by way of a voice bridge 115. (In embodiments where the method of the present invention is provided as a subscription service, at least one of the caller 200 and the called party 210 is a subscriber to the service.)

At some point during this first call, typically in the case of call centers just after call completion, one party places the other party on hold. (For ease of reference, the example below will be given in terms of the caller being put on hold by the called party, but the opposite case can likewise be achieved.) After the called party 210 has placed the caller 200 on hold, the caller 200 either places a second outgoing call (e.g., using the flash hook on a conventional telephone or a similar button on a Voice over IP phone) or receives a second incoming call via call waiting services to/from a third party 220 (labeled “Party B”). In either case, the caller 200 is no longer monitoring the status of the first call but is instead interacting with the second call (or is no longer connected at all). In the subscriber's place, the voice detection and response module 105 is left to monitor the status of the first call.

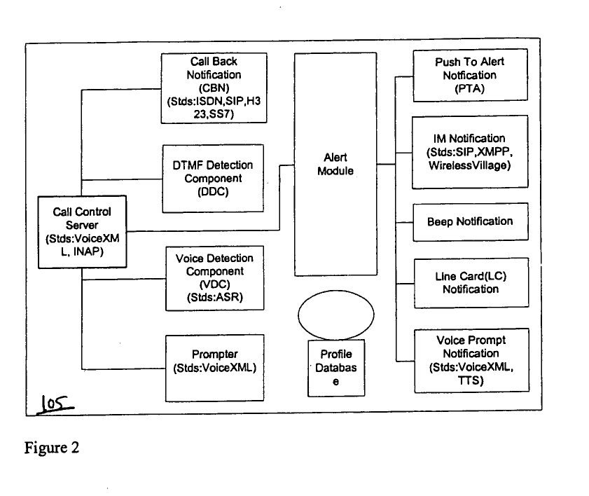

FIG. 2 illustrates an exemplary embodiment of the voice detection and response module 105 which monitors a held call no longer monitored by the caller 200 directly. When the voice detection and response module 105 detects that the called party has returned to the first call, the voice detection and response module 105 signals the caller of this change. As will be described in greater detail below, the voice detection and response module 105 can notify the caller via any method that attracts the caller's attention, including, but not limited to, at least one of any of the following methods: (1) sending a visual indication to communication terminal, such as a glowing LED or a flashing second line; (2) initiating a distinctive tone or beep, which gets the user's attention; (3) sending an instant message; and (4) sending a unidirectional voice whisper from the waiting party (e.g., “Hanging up, At home till 5:00.”). Moreover, the detection of the return of the called party can be based on any one of at least the following techniques: (1) live voice detection (with filtering to ignore pre-recorded voice messages), (2) DTMF detection, or (3) explicit signaling to the voice detection and response module 105 using out-of-band communication between the called party and the voice detection and response module 105.

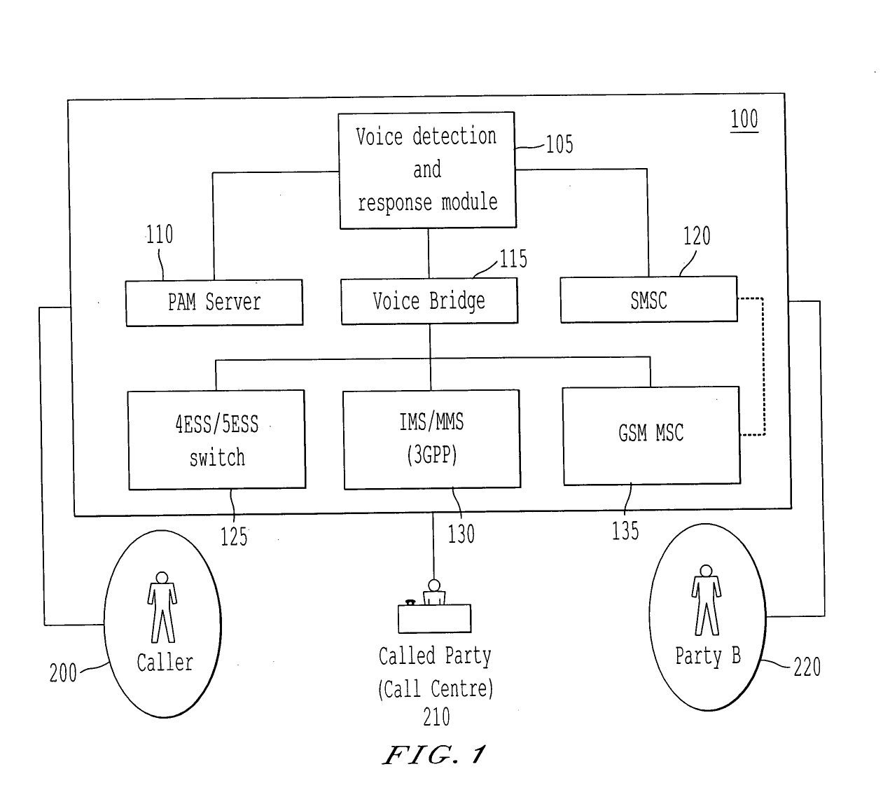

As shown in FIG. 1, in order to provide out-of-band notifications to the caller 200, the system 100 may also include a presence and messaging server 110 that can interact with the caller using instant messaging, SMS or other text messaging functions. Similarly, the system 100 may also include a short message service center 120 that can provide SMS messages and the like without having to require a presence server. Similarly, the IMS/MMS module 130 provides support for signaling (and voice) in 3GPP and 3GPP2 systems which allow internet access for mobile customers in an integrated voice, web and messaging environment.

Turning now to FIG. 2, the voice detection and response module 105 can include one or more of the following components: (1) a call park server, (2) detection and prompting services, (3) call back notification, (4) alerting services and (5) a profile database. Each of these is discussed in greater detail below.

The overall process of detection and notification is handled by a call park server (CPS). The call park server acts as an interactive voice response (IRV) unit or a voice response unit (VRU) and handles how a non-monitored call is “parked” until one of the parties is ready to start interacting again. The CPS utilizes detection services and alert (or notification) services to accomplish its general functions. The CPS can utilize a variety of standards to handle call control (e.g., ISUP, ISDN, TUP, SS7, SIP, H323 and VoiceXML).

The detection and prompting services detect the return of the party that initially placed the call on hold. Such detection services can be provided by a DTMF detection component (DDC) that detects the return of the caller by an explicit DTMF tone pattern entered by the returning party. Such detection services also can be provided by a voice detection component (VDC) that recognizes the presence of live voice. Such a unit preferably is able to distinguish between live voice and holding signals. Holding signals can include any one or more of: hold music, pre-recorded marketing blurbs and automated prompts, white noise and silence. This detection can utilize standards such as Automatic Speech Recognition (ASR). The detection of live voice can be facilitated by detecting the loss of an embedded signal (e.g., an inaudible watermark) that is embedded in the holding signals (but not in the live voice). Such voice detection services may likewise be programmed to listen for particular voice sequences to aid in the detection of live voice. Such voice sequences may include “Hello” and “Are you there”.

In addition to the detection services, it is also possible to utilize prompting services to inform the party that has come off of hold (e.g., the customer service center that initially put the caller on hold) that the system is trying to prompt the caller to return to the call. This may reduce the number of times that a party coming off hold hangs up prematurely since it doesn't realize that the caller will be notified of the change in call status. Such prompting may utilize a VoiceXML-style standard and text-to-speech conversion or pre-recorded voice.

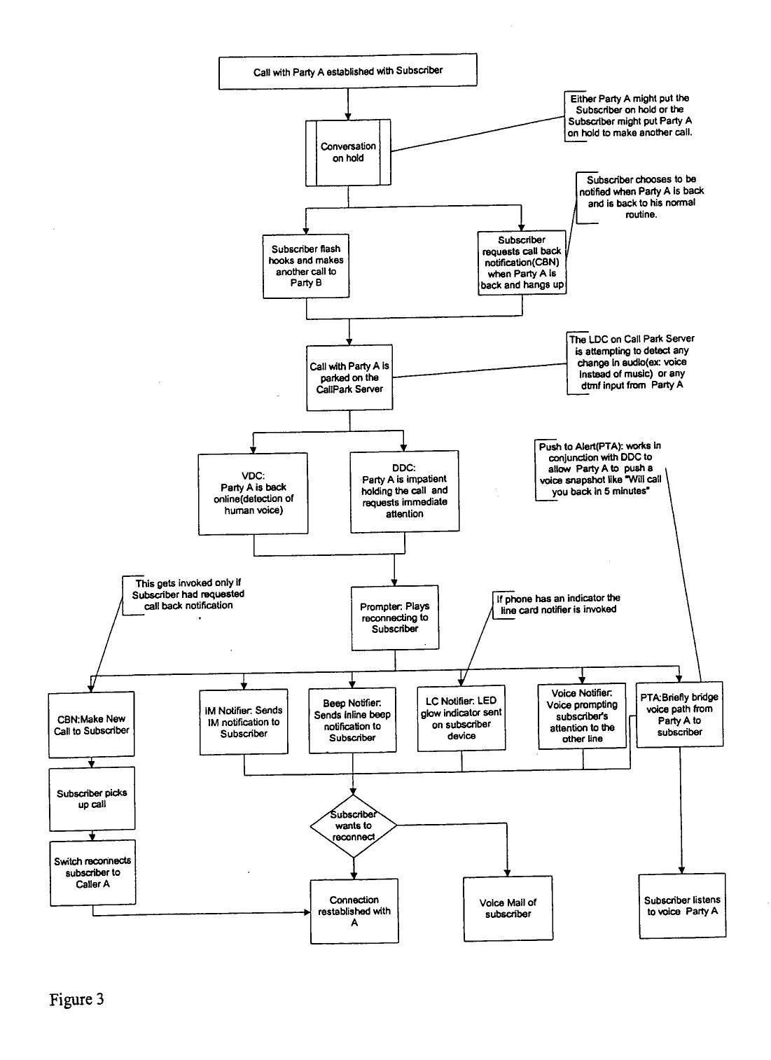

When the CPS determines from the detection services that the called party has returned, the CPS utilizes alerting services to inform the caller that the originally called party has returned. The alerting services can utilize any in-band or out-of-band mechanisms for this notification. As illustrated in FIG. 3, non-limiting examples of such alerting services may include (1) push-to-alert notification, (2) Instant Messaging services (e.g., SIP, XMPP, Wireless village, AOL Instant messenger) and email services, (3) beep notification (e.g., either inserted by the switch or added through a bridge controlled by the CPS), (4) line card notification (e.g, for display devices), and (5) voice prompt notifications. The push-to-alert notification allows the called party A to briefly interrupt the caller's conversation with party B to alert the caller that party A is back. The instant messaging services and email services can send a message to a pre-defined address (e.g., as specified in the profile database) to get the attention of the subscriber. For line card notification, a light or other notification device on the caller's phone may be illuminated or strobed. The voice prompt notifications may either stored in any form by the bridge and played back by the bridge.

Other examples of services provided by the Call Park Server include the ability to have the caller disconnect (e.g., to save on wireless minutes) and be contacted later using a callback notification (CBN) service. In such an embodiment, the CPS “stands in line” on behalf of the callee. When the CPS detects that the called party has come back on the line, the CPS (via the CBN) dials backs the number of the original caller (or some other number associated with the caller, for example either entered before disconnecting or stored in the profile database). If the original caller does not have a direct dial line, the system may have to use a multi-part dialing sequence that involves an initial set of digits, a pause, and then a subsequent set of digits. Alternatively, the system may call a main number and then play a recorded message to an attendant asking for the caller. (All such callback information can be saved on behalf of the user in the profile database.) When the CPS is reconnecting the caller to the called party, the CPS again may optionally utilize voice prompts to encourage the called party to remain on the line until the original caller is reached. Moreover, the CPS may utilize a list of numbers that it dials (e.g., in a pre-specified order) until it reaches the original caller. This callback process enables the caller to maintain his or her “place in line” with customer service without actually requiring the original caller to be connected with anyone. The CBN may utilize protocols such as SIP, H323, ISDN and SS7 to aid with call transfer and/or third party call control.

Similarly, rather than having the CPS dial out to the original caller, the CPS can contact the original caller via some other communications service (e.g., instant messaging, SMS or email) and provide the original caller with some period of time in which to call back the CPS. If the original caller does call back the CPS, the CPS then reconnects the original caller to the originally called party. If the caller does not call back, the called party is sent to a voicemail corresponding to the caller.

Turning to FIG. 3, the flowchart of FIG. 3 illustrates an embodiment of various methods of utilizing a CPS of the present invention. The caller (which is still the subscriber in the illustrated example) establishes a connection with a called party A. This may be either a direct dial service (i.e., by just dialing the number of the called party A) or an intermediate service. A direct dial service may be used when the call control system 100 is automatically interposed between the caller and the called party A (when the call control system 100 is in part of a local branch exchange or in the public switched network or when a the call control system 100 is part of a voice-over-IP network). The use of an intermediate service may include dialing a pre-defined number (e.g., an 800 or other toll-free number), identifying the caller to the intermediate service (e.g., using ANI and a PIN), and sending the number of the called party A to the intermediate service via DTMF tones such that the intermediate service then connects the caller to the called party A. In yet another embodiment, the CPS may be part of a call distribution system that is part of the phone system of the called party. In such an embodiment, the caller need not subscribe to a service since the service can be provided by the called party, especially where a callback service is used.

One of the two parties (either the caller or the called party A) may then place the other party on hold. In the context of the original caller remaining on hold, this may involve the caller flash hooking and making a call to another party B. In the context of the caller wanting to not remain physically on hold, the subscriber identifies that it wants to use callback notification (e.g., using a DTMF sequence) and hangs up.

In either hold mode, the CPS “parks” the call between the original caller and the originally called party and the CPS continues to detect whether the originally called party is no longer on hold. Such a detection utilizes one or more of a voice detection component (VDC) and a DTMF detection component (DDC). Optionally, the prompter may play a prerecorded prompt indicating that the CPS is contacting the subscriber or play a user recorded message. The message from the subscriber may be a message from the subscriber that is independent of the call or may be a message that is call-dependent.

For example, in a call-dependent message, the subscriber may inform the CPS during the call (and before switching to a second call) that the caller wishes to record a message to be played to the called party when the called party comes back on line. When prompted, the caller would then record its message. When the called party comes on the line, the CPS would then play the message to the called party. For example, the caller may record its customer number and the reason for its call so that the caller (e.g., a customer service agent) can begin to investigate the issue that the caller is calling about while the caller is still in its place in line. (This is opposed to a call center that returns calls when it is convenient to the call center.)

In such a call-dependent message embodiment, the CPS may initially detect that the called party has returned (e.g., by voice or DTMF detection) and the CPS therefore sends a first notification to the caller. After the called party receives the message recorded by the caller, the called party may enter a voice or DTMF sequence to let the CPS know that the called party is going to hold onto the call, even if the caller does not immediately return because the called party has work that it can do in the meantime. (This can override any roll-over to the caller's voicemail if the caller does not return immediately.) Later, when the called party has completed the work that it has to do, the called party may utilize a voice or DTMF sequence which is designed to inform the CPS that it should notify the caller that the called party is done. At that point, the CPS may signal the caller again such that the caller is encouraged to switch back to the call. If the caller does not switch back, the called party can leave a message for the caller (e.g., describing that the travel reservations or hotel is confirmed). Otherwise, if the caller does return to the call, the CPS joins the caller to the called party so that they can carry on a live conversation.

As is to be understood from the above example, the party that placed the call on hold initially may (manually) signal the other party more than once after returning to the call. Unlike a call waiting tone that may occur at predetermined intervals but whose later tones are not user generated, it is possible according to the present invention to allow the returning party to determine when the multiple tones (or other notifications) are sent to the party on the other call.

In an embodiment utilizing callback notification, after the detection services detect that the called party has returned to the call, the CPS (via the CBN) calls back the subscriber, waits for the subscriber to pick up the phone and reconnects the caller to the called party A.

In embodiments not utilizing callback notification, one of the alert services is utilized to get the attention of the subscriber. If the subscriber switches back to the original call within a predetermined amount of time, the CPS re-establishes the connection between the caller and the called party A. If not, the CPS connects the called party A to a voicemail system associated with the caller.

The CPS of the present invention (and any of its individual components) can be implemented using any one or a combination of software, hardware and special purpose circuitry. In a software-based system, a memory (volatile or non-volatile) stores a series of instructions that implement the functionality described herein. The hardware (including a general purpose processor or an application specific processor) executes the instructions stored in the memory. Such instructions may be in the form of any program, scripts, interpreted code, etc. A computer program product according to the present invention includes a computer readable medium with instructions embedded therein for performing one or more functions of the present invention.

Numerous modifications of the above-teachings will be apparent to those of ordinary skill in the art without departing from the general principles set forth herein.

1. A call control system for monitoring a status of a call between a caller and a called party, comprising:
a hold detection component for detecting that the call between the caller and the called party has been placed on hold;
a detection component for detecting that the call between the caller and the called party is no longer on hold;
a notification component for sending a notification that the call is no longer on hold to the one of the caller and the called party that did not initiate putting the call between the caller and the called party on hold; and
a call control component for re-establishing the call between the caller and the called party in response to the notification sent out by the notification component.

2. The call control system as claimed in claim 1, wherein the detection component comprises a voice detection component.

3. The call control system as claimed in claim 1, wherein the detection component comprises a DTMF detection component.

4. The call control system as claimed in claim 1, wherein the notification component comprises an in-band notification component.

5. The call control system as claimed in claim 1, wherein the notification component comprises an out-of-band notification component.

6. The call control system as claimed in claim 4, wherein the in-band notification component comprises a bridge for sending a tone to the one of the caller and the called party that did not initiate putting the call between the caller and the called party on hold.

7. The call control system as claimed in claim 5, wherein the out-of-band notification component comprises a push-to-alert notification component.

8. The call control system as claimed in claim 5, wherein the out-of-band notification component comprises an instant messaging component.

9. The call control system as claimed in claim 5, wherein the out-of-band notification component comprises a line card notification component.

10. The call control system as claimed in claim 5, wherein the out-of-band notification component comprises an SMS messaging component.

11. A call control method for monitoring a status of a call between a caller and a called party, comprising:
detecting that the call between the caller and the called party has been placed on hold;
detecting that the call between the caller and the called party is no longer on hold;
sending a notification that the call is no longer on hold to the one of the caller and the called party that did not initiate putting the call between the caller and the called party on hold; and
re-establishing the call between the caller and the called party in response to the notification sent out by the notification component.

12. The call control method as claimed in claim 11, wherein detecting that the call is no longer on hold comprises performing voice detection.

13. The call control method as claimed in claim 11, wherein detecting that the call is no longer on hold comprises performing DTMF detection.

14. The call control method as claimed in claim 11, wherein the step of sending comprises sending an in-band notification.

15. The call control method as claimed in claim 11, wherein the step of sending comprises sending an out-of-band notification.

16. The call control method as claimed in claim 14, wherein the in-band notification comprises utilizing a bridge for sending a tone to the one of the caller and the called party that did not initiate putting the call between the caller and the called party on hold.

17. The call control method as claimed in claim 15, wherein the out-of-band notification comprises a push-to-alert notification.

18. The call control method as claimed in claim 15, wherein the out-of-band notification comprises an instant message.

19. The call control method as claimed in claim 15, wherein the out-of-band notification comprises a line card notification.

20. The call control method as claimed in claim 15, wherein the out-of-band notification comprises an SMS message.
